(19) United States
(12) Patent Application Publication
(10) Pub. No.: US 2025/0111155 A1
(43) Pub. Date: Apr. 3, 2025

(54) SYSTEMS AND METHODS FOR TEXT GENERATION WITH VOCABULARY DETOXIFICATION

(71) Applicant: Salesforce, Inc., San Francisco, CA (US)

(72) Inventors: Tong Niu, Sunnyvale, CA (US); Yingbo Zhou, Palo Alto, CA (US); Silvio Savarese, Palo Alto, CA (US); Semih Yavuz, Redwood City, CA (US); Caiming Xiong, Menlo Park, CA (US)

(21) Appl. No.: 18/416,612

(22) Filed: Jan. 18, 2024

Related U.S. Application Data
(60) Provisional application No. 63/586,334, filed on Sep. 28, 2023.

(51) Int. Cl. G06F 40/284

(52) U.S. Cl. CPC G06F 40/284

(57) ABSTRACT

Embodiments described herein provide a method for mitigating toxic content in text generation by a neural network based framework. The method includes the following operations. A text input of a sequence of tokens is received via a communication interface. A first output probability for a next token generating is generated by a first neural network model that is trained to generate tokens belonging to a prioritized category of vocabulary, in response to the text input. A second output probability of the next token is generated by a second neural network model that is trained to generate tokens belonging to an indiscriminate vocabulary, in response to the text input. The next token for a text output based on a combined output probability computed based on a correction item reflective of the first output probability and the second output probability is generated in response to the text input.

### CROSS REFERENCE(S)

The instant application is a nonprovisional of and claim priority under 35 U.S.C. 119 to U.S. provisional application No. 63/586,334, filed Sep. 28, 2023, which is hereby expressly incorporated by reference herein in its entirety.

### TECHNICAL FIELD

The embodiments relate generally to machine learning systems for language processing by language models, and more specifically to systems and methods for text generation neural network framework with vocabulary detoxification.

### BACKGROUND

Machine learning systems have been widely used in language processing. For example, generative artificial intelligence (AI) models have been used widely in applications such as text generation, image generation, speech and audio generation, video generation, etc. However, as generative AI models are largely trained on various corpus of training data to generate a new text, the generated texts may sometimes incorporate unwanted language, such as biased, racially insensitive, and/or other unwanted “toxic” content.

Therefore, there is a need for a technique to mitigate toxic generative content from generative AI models.

### BRIEF DESCRIPTION OF THE DRAWINGS

FIG. 1A is a simplified diagram illustrating a detoxification framework, according to some embodiments.

FIG. 1B is a simplified diagram illustrating a training process of a detoxifier model, according to some embodiments.

FIG. 2 is a simplified diagram illustrating a computing device implementing the detoxification framework described in FIGS. 1A and 1B, according to some embodiments.

FIG. 3 is a simplified diagram illustrating a neural network structure, according to some embodiments.

FIG. 4 is a simplified block diagram of a networked system suitable for implementing the detoxification framework described in FIGS. 1A and 1B and other embodiments described herein.

FIG. 5 is an example logic flow diagram illustrating a method of detoxification based on the framework shown in FIGS. 1A and 1B, according to some embodiments.

FIGS. 6A-6F provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

### OVERVIEW

Existing generative AI models, which are trained with various corpus of training data (such as texts obtained from the Internet), may sometimes generate “toxic” content, e.g., languages that are hate speech, offensive content, misinformation, privacy content, insensitive content, and so on. Some controllable text generation techniques have developed aiming to mitigate or avoid undesirable/harmful behavior of the AI models, such as generating toxic content. Existing detoxification methods often rely on full-model finetuning of generative AI models. As generative AI models such as LLMs can be computationally heavy, multiple rounds of finetuning can be expensive and time consuming.

In view of the need for a technique to finetune generative AI models to generate detoxified text content without resource-intensive finetuning for detoxification, embodiments described herein provide a generative AI framework that removes toxic content in a language model output without full-model finetuning the language model. Specifically, the generative AI framework includes a detoxifier model (e.g., a first language model) and a generator model (e.g., a second language model). The detoxifier model is trained to output a high probability of toxic content for the next token using human-annotated toxic data. At inference, the same input prompt is fed to both the detoxifier model and the generator model. The detoxifier model may generate a probability distribution for the next token having a high probability to be toxic vocabulary, while the generator may output a probability distribution for the next token over an indiscriminate vocabulary. Thus, the final output may be determined based on the output probabilities of the detoxifier model and the generator model such that the likelihood the next token being toxic can be subtracted or mitigated.

In this way, the neural network models generate a text output that removes and/or mitigates toxic content without any expensive finetuning of the generator model. Computational efficiency of text generation neural networks have thus been improved. In addition, the detoxification is controllable by users through the tuning of the detoxifier model. For example, the detoxifier model may be finetuned with training datasets that are designed to favor or disfavor a certain prioritized category of vocabulary, e.g., to favor neural language and disfavor toxic content in generating the next token. Therefore, neural network technology in natural language generation (NLG) is improved with a high efficiency generation neural network and user-controllable generation vocabulary.

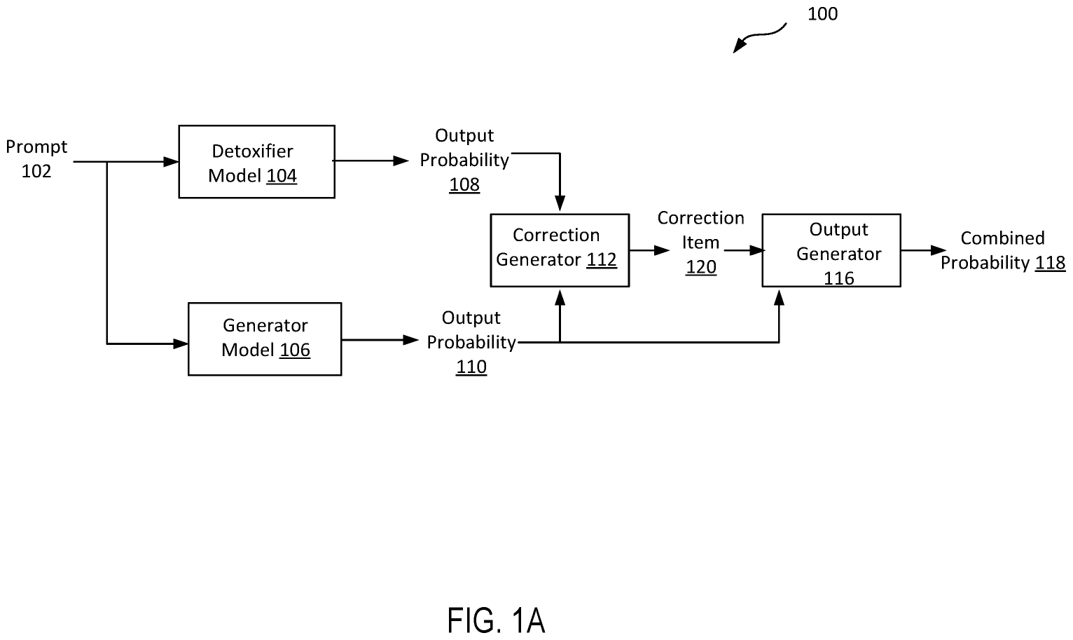

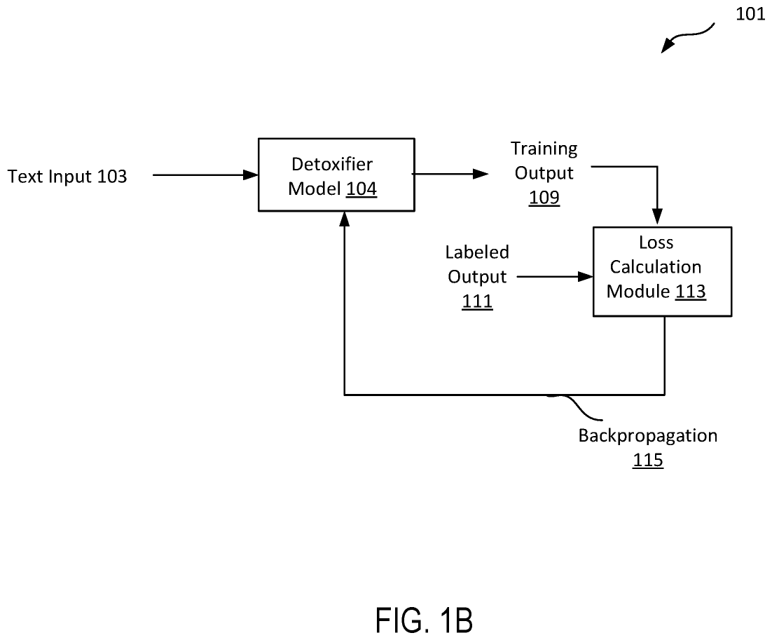

FIG. 1 is a simplified diagram illustrating a controllable text generation framework 100 according to some embodiments. Controllable text generation framework 100 includes a detoxifier model 104, a generator model 106, a correction generator 112, and an output generator 116. Detoxifier model 104 and generator model 106 may be operatively connected to correction generator 112. Generator model 106 and correction generator 112 may be operatively connected to output generator 116. An input of controllable text generation framework 100 may include a text of plurality of tokens (e.g., a prompt 102) in a sequence. An output of controllable text generation framework 100 may include a probability (e.g., a combined probability 118) of the next token of the plurality of tokens. In some embodiments, combined probability 118 being in a prioritized category of vocabulary (e.g., words considered as toxic) is reduced. In some embodiments, detoxifier model 104 and generator model 106 may be pre-trained neural network models. In some embodiments, in inference stage, the weights in detoxifier model 104 and generator model 106 may be frozen, e.g., unchanged.

For example, a prioritized category of vocabulary may refer to a set of words that are considered more important or essential within a specific context or domain. For example, a prioritized category of vocabulary can include terms related to toxic, harmful, and/or hateful content. In an example, a prioritized category of vocabulary may include only toxic vocabulary. A prioritized category of vocabulary can also include any user-desired or undesired category of words, although not used in the embodiments of the present disclosure. For example, a prioritized category of vocabulary may include medical jargons. A user may exclude/filter out the medical jargons from the output of a framework such that the generative output is easier for a non-medical professional (e.g., a patient) to understand. An indiscriminative vocabulary may refer to a set of words that are not selective or discerning. For example, an indiscriminative vocabulary may include a broad range of words without specific criteria for inclusion. For example, an indiscriminative vocabulary may include both toxic and non-toxic vocabulary. In an example, an indiscriminative vocabulary may include common vocabulary of a dictionary.

Detoxifier model 104 may be a language model trained/finetuned to generate, if given a text input of a plurality of tokens, tokens belonging to a prioritized category of vocabulary. In some embodiments, the prioritized category of vocabulary may include undesirable features such as insensitive, harmful, and/or offensive content. For example, the prioritized category may include toxic content. Examples of toxic content may further include hate speech, violence, threats, misinformation, inappropriate language, offensive language, bias, or a combination thereof. Detoxifier model 104 may include any suitable language model such generative pre-trained transformer 2-large (GPT2-large), Llama-2, etc. Detoxifier model 104 may be trained to generate an output probability 108 for the next token in response to an input of prompt 102.

For example, the prompt 102 may be a text input such as a request to perform a NLG task. The text input may be a question for an answer, a document for summarization task, a block of text for rephrasing, and/or the like. The prompt 102 may further include an instruction for the language model such as the detoxifier model 104 on how to generate an output, e.g., the instruction may comprise “You are a sales agent to explain to the user on the specifics in response to the user input question,” etc. For another example, the prompt 102 may comprise a multi-modal input such as image, audio, video, code, and/or the like. For instance, the prompt 102 may comprise an image and a text query asking “what is this image about?”

In one embodiment, prompt 102 (represented by x_{<t}=x₁, x₂, . . . , xₜ₋₁) may include a sequence of (t-1) tokens, each xᵢ (1≤i≤t-1) being a token in a vocabulary set V of generator model 106. Detoxifier model 104 may compute an output probability 108 P_{CON}(Xₜ|x_{<t}) over |V|. As described below, detoxifier model 104 may be trained to generate a high probability of next token (Xₜ) over a prioritized category of vocabulary (e.g., a set of toxic words).

Generator model 106 may be configured to generate, if given a text input of a plurality of tokens, a “normal” probability for a next token. In some embodiments, generator model 106 is trained to generate tokens belonging to an indiscriminate vocabulary, such as V, (e.g., the common vocabulary of a dictionary). In some embodiments, generator model 106 is not trained/finetuned to generate tokens belonging to the prioritized category of vocabulary, such as a set of toxic words. Generator model 106 may include any suitable language model such GPT2-large, Llama-2, etc. In some embodiments, detoxifier model 104 and generator model 106 have the same backbone model. For example, the backbone model may include GPT2-large.

Generator model 106 may have an input of prompt 102 (e.g., same as detoxifier model 104), and an output of output probability 110. When given prompt 102, generator model 106 may encode x_{<t} in an autoregressive fashion and computes zₜ∈ [symbol] ^{|V|}, where zₜ denotes the logits for the t^{th} token xₜ and |V| corresponds to the vocabulary size. Generator model 106 may then compute an output probability 110 PGEN over V by P_{GEN}(xₜ|x_{<1})=softmax (zₜ). The next token may be sampled from this distribution.

Correction generator 112 may generate a correction item 120 reflective of output probability 108 and output probability 110. Correction generator 112 may have inputs including output probability 108 and output probability 110, and may have an output of a correction item 120. In some embodiments, correction generator 112 computes correction item as c=αΔP, where ΔP=P_{GEN}−P_{CON} and α is a hyperparameter. In some embodiments, ΔP represents the probability correction term determined by the difference between the two probability distributions, i.e., P_{GEN} and P_{CON}, and a represents the control strength of detoxifier model 104. For example, a represents the level of control over generator model 106's probability distribution through correction item ΔP. Hyperparameter α may be tuned to implement a desired level of control, and manipulate the output probability of controllable text generation framework 100. Hyperparameter α is tuned to lower the output probability 108 based on the difference between the output probabilities 108 and 110, such that the output probability of toxic content by the controllable text generation framework 100 is mitigated. In some embodiments, a ranges from 1 to 9. For example, α may be equal to 5, e.g., to achieve the best balance between toxicity and generation quality.

Output generator 116 may compute an output probability of controllable text generation framework 100. Output generator 116 may have inputs including correction item 120 and output probability 110, and an output that is a combined probability 118 of correction item 120 and output probability 110. In some embodiments, output generator 116 computes combined probability 118 as P(xₜ|x_{<t})=P_{GEN}+αΔP.

In some embodiments, to ensure the value of combined probability 118 (e.g., P(xₜ|x_{<t})) is between [0.0, 1.0], a sampling technique is performed to limit the prioritized category of vocabulary V to a subset V^{(p)} by only selecting highest probability tokens whose cumulative probability mass exceeds a pre-defined threshold value p∈[0.0, 1.0]. In some embodiments, the top-p vocabulary subset V^{(p)}⊆V may be defined by the smallest vocabulary set such that Σ_{x∈V}_{^{(p)}} P_{GEN}(xₜ|x_{<t})≥p. In an example, p may be equal to 0.9. The top-p sampling then truncates the less reliable tail of the distribution by setting

$${P}^{′} [ x ] = \{ \begin{matrix}P [ x \} , & if x ∈ {V}^{( p )} \\ 0 , & otherwise .\end{matrix}$$

Detoxifier model 104 then comes in and manipulates logits in the set V (P) so that regardless of how P_{GEN} is modified, the generated tokens are guaranteed to be plausible as evaluated by generator model 106. When applying this restriction, combined probability 118 may become

$${P}^{′} ( {x}_{t} \vert {x}_{< t} ) = {( {P}^{′} )}_{G E N} + α ( {{P}^{′}}_{GEN} - {{P}^{′}}_{C O N} )$$

In one embodiment, the combined probability 118 may then be used to predict a next output token, e.g., via a softmax operation, etc., to form the output in response to input prompt 102.

FIG. 1B illustrates the training of detoxifier model 104 at the training stage, according to some embodiments. In some embodiments, detoxifier model 104 may be chosen as a language model that is much smaller in size compared to the generator model 106. Thus, training detoxifier model 104 only can be much computationally efficient.

The training data of detoxifier model 104 may be designed to force the detoxifier model 104 to generate an output favoring words, phrases, sentences, and/or the like from a user-defined prioritized category of vocabulary. For example, training pairs may include a text input (e.g., 103) and a corresponding labeled output (e.g., 111) belonging to the prioritized category of vocabulary, such as a toxic vocabulary. In some embodiments, training data may be extracted from human-annotated Jigsaw Unintended Bias in Toxicity Classification (Borkan et al., Jigsaw unintended bias in toxicity classification, 2019.). An example (e.g., a corresponding labeled output 111) is considered toxic if more than 50% of the annotators classify it as toxic. This threshold splits the corpus into around 160K toxic and 1.4M nontoxic examples. Detoxifier model 104 may be trained with the toxic part of the data.

At training stage, in response to a training text input 103, detoxifier model 104 may generate a conditional probability distribution of the next token in the training output 109 given the preceding context. For example, 100 virtual tokens may be used for each model with a learning rate of 0.1. In some embodiments, PEFT (Parameter-Efficient Fine-Tuning) is used such that virtual tokens are prepended to the input only for the first generation step.

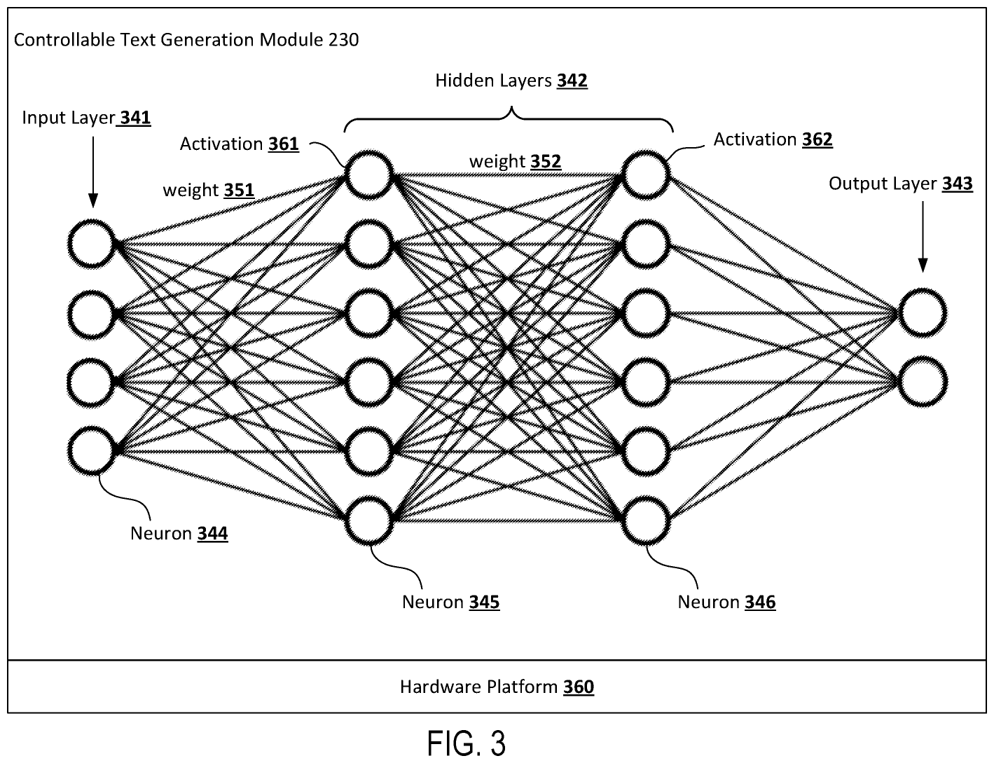

For example, the generated training output 109 may be compared with the labeled output 111 to compute a loss at loss calculation module 113, such as a cross-entropy loss. The loss may then be used to update the detoxifier model 104 via a backpropagation path 115. Additional details of updating a neural network via backpropagation may be discussed below in relation to FIG. 3.

To further improve training efficiency, the weights of detoxifier model 104 may be frozen, e.g., during backpropagation. Instead of updating the weights of the detoxifier model 104, the embedding of virtual tokens that are prepended to the input may be tuned during backpropagation according to the loss objective during a training iteration. For example, virtual token embeddings may be inserted among input text embeddings or may be attached to input text embeddings. The virtual token embeddings and the input text embeddings may be passed on to the rest of detoxifier model 104. In some embodiments, the number of virtual tokens generated by detoxifier model 104 is about 100, and the learning rate is equal to 0.1.

### Computer and Network Environment

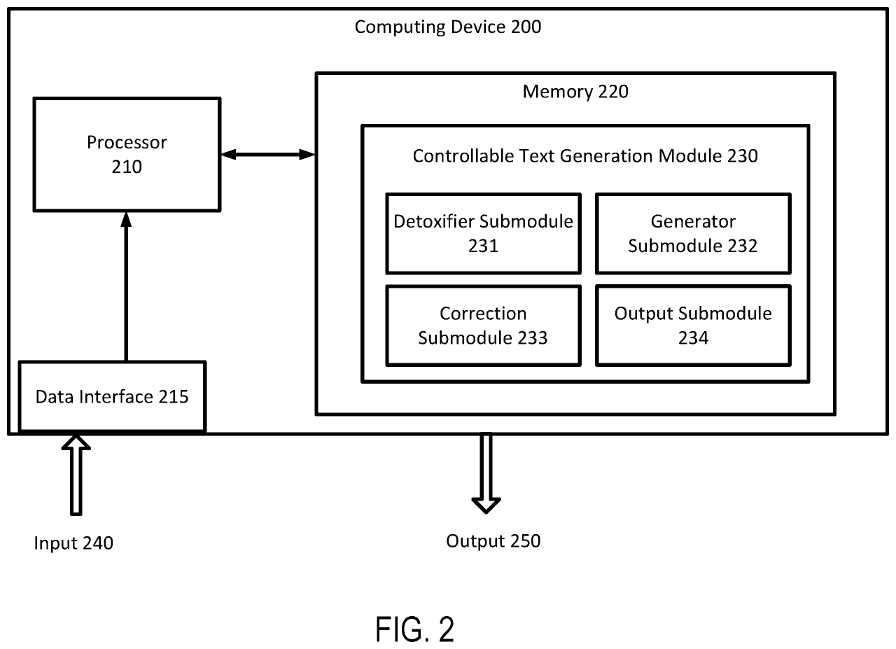

FIG. 2 is a simplified diagram illustrating a computing device implementing the controllable text generation framework 100 described in FIGS. 1A and 1B, according to one embodiment described herein. As shown in FIG. 2A, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for controllable text generation module 230 that may be used to implement and/or emulate the systems and models, and/or to implement any of the methods described further herein. controllable text generation module 230 may receive input 240 such as an input training data (e.g., prompt 102) via the data interface 215 and generate an output 250 which may be combined probability 118.

The data interface 215 may comprise a communication interface, a user interface (such as a voice input interface, a graphical user interface, and/or the like). For example, the computing device 200 may receive the input 240 (such as a training dataset) from a networked database via a communication interface. Or the computing device 200 may receive the input 240, such as prompt 102, from a user via the user interface.

In some embodiments, the controllable text generation module 230 is configured to mitigate toxic content in the output. The controllable text generation module 230 may further include a detoxifier submodule 231 (e.g., similar to detoxifier model 104 in FIG. 1A), a generator submodule 232 (e.g., similar to generator model 106 in FIG. 1A), a correction submodule 233 (e.g., similar to correction generator 112 in FIG. 1A), and an output submodule 234 (e.g., similar to output generator 116 in FIG. 1A). Detoxifier submodule 231 may be configured to generate tokens that are toxic (e.g., belonging to a toxic vocabulary) in response to a prompt of a plurality of tokens, and may output a first output probability for a next token. Generator submodule 232 may be configured to generate tokens that are indiscriminative (e.g., belong to an indiscriminative vocabulary) in response to the same prompt, and may output a second output probability for the next token. Correction submodule 233 may be configured to generate a correction item based on the difference between the first output probability and the second output probability. Output submodule 234 may be configured to generate a combined probability as the output of controllable text generation module 230. The combined probability may be a combination of the second output probability and correction item.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 3 is a simplified diagram illustrating the neural network structure implementing the controllable text generation module 230 described in FIG. 2, according to some embodiments. In some embodiments, the controllable text generation module 230 and/or one or more of its submodules 231-234 may be implemented at least partially via an artificial neural network structure shown in FIG. 3. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 240 in FIG. 2), such as a prompt. The number of nodes (neurons) in the input layer 341 may be determined by the dimensionality of the input data (e.g., the length of a vector of the prompt). Each node in the input layer represents a feature or attribute of the input.

The hidden layers 342 are intermediate layers between the input and output layers of a neural network. It is noted that two hidden layers 342 are shown in FIG. 3 for illustrative purpose only, and any number of hidden layers may be utilized in a neural network structure. Hidden layers 342 may extract and transform the input data through a series of weighted computations and activation functions.

For example, as discussed in FIG. 2, the controllable text generation module 230 receives an input 240 of prompt and transforms the input into an output 250 of a combined probability. To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the controllable text generation module 230 and/or one or more of its submodules 231-234 may comprise the transformative neural network structure of layers of neurons, and weights and activation functions describing the non-linear transformation at each neuron. Such a neural network structure is often implemented on one or more hardware processors 210, such as a graphics processing unit (GPU). An example neural network may be GPT2-large, and/or the like.

In one embodiment, the controllable text generation module 230 and its submodules 231-234 may be implemented by hardware, software and/or a combination thereof. For example, the controllable text generation module 230 and its submodules 231-234 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

In one embodiment, the neural network based controllable text generation module 230 and one or more of its submodules 231-234 may be trained by iteratively updating the underlying parameters (e.g., weights 351, 352, etc., bias parameters and/or coefficients in the activation functions 361, 362 associated with neurons) of the neural network based on the loss described FIG. 1B. For example, during forward propagation, the training data such as text input are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding labeled output) from the training data, to compute a loss function that measures the discrepancy between the predicted output and the expected output. For example, the loss function may be a cross entropy loss. Given the loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

Parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating an output probability in response to a prompt.

In some embodiments, parameters and/or weights of the neural network may be frozen during backward updating based on the loss, for computational efficiency. Instead, the prompt (e.g., a set of tokens, or virtual tokens representing input instructions or queries given to the model to generate responses) or the virtual token embeddings of the prompt may be updated, e.g., as an extension of the neural network, during backpropagation in a similar manner as described above, as discussed in relation to FIG. 1B.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in controllable text generation by language models.

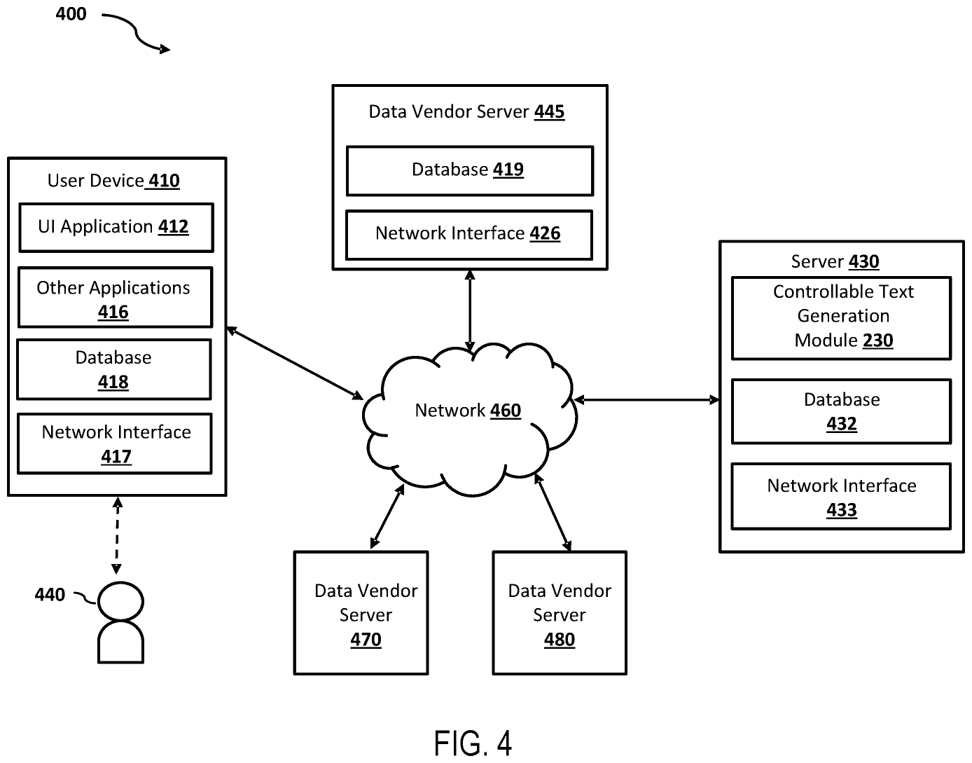

FIG. 4 is a simplified block diagram of a networked system 400 suitable for implementing the detoxification framework described in FIGS. 1A and 1B and other embodiments described herein. In one embodiment, system 400 includes the user device 410 which may be operated by user 440, data vendor servers 445, 470 and 480, server 430, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 410, data vendor servers 445, 470 and 480, and the server 430 may communicate with each other over a network 460. User device 410 may be utilized by a user 440 (e.g., a driver, a system admin, etc.) to access the various features available for user device 410, which may include processes and/or applications associated with the server 430 to receive an output data anomaly report.

User device 410, data vendor server 445, and the server 430 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

User device 410 may be implemented as a communication device that may utilize appropriate hardware and software configured for wired and/or wireless communication with data vendor server 445 and/or the server 430. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and/or other applications 416, which may correspond to executable processes, procedures, and/or applications with associated hardware. For example, the user device 410 may receive a message indicating the predicted next token from the server 430 and display the message via the UI application 412. In other embodiments, user device 410 may include additional or different modules having specialized hardware and/or software as required.

In various embodiments, user device 410 includes other applications 416 as may be desired in particular embodiments to provide features to user device 410. For example, other applications 416 may include security applications for implementing client-side security features, programmatic client applications for interfacing with appropriate application programming interfaces (APIs) over network 460, or other types of applications. Other applications 416 may also include communication applications, such as email, texting, voice, social networking, and IM applications that allow a user to send and receive emails, calls, texts, and other notifications through network 460. For example, the other application 416 may be an email or instant messaging application that receives a prediction result message from the server 430. Other applications 416 may include device interfaces and other display modules that may receive input and/or output information. For example, other applications 416 may contain software programs for asset management, executable by a processor, including a graphical user interface (GUI) configured to provide an interface to the user 440 to view the predicted next token.

User device 410 may further include database 418 stored in a transitory and/or non-transitory memory of user device 410, which may store various applications and data and be utilized during execution of various modules of user device 410. Database 418 may store user profile relating to the user 440, predictions previously viewed or saved by the user 440, historical data received from the server 430, and/or the like. In some embodiments, database 418 may be local to user device 410. However, in other embodiments, database 418 may be external to user device 410 and accessible by user device 410, including cloud storage systems and/or databases that are accessible over network 460.

User device 410 includes at least one network interface component 417 adapted to communicate with data vendor server 445 and/or the server 430. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 445 may correspond to a server that hosts database 419 to provide training datasets including human-annotated training pairs of text inputs and corresponding labeled outputs to the server 430. The database 419 may be implemented by one or more relational database, distributed databases, cloud databases, and/or the like.

The data vendor server 445 includes at least one network interface component 426 adapted to communicate with user device 410 and/or the server 430. In various embodiments, network interface component 426 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 445 may send asset information from the database 419, via the network interface 426, to the server 430.

The server 430 may be housed with the controllable text generation module 230 and its submodules described in FIG. 2A. In some implementations, controllable text generation module 230 may receive data from database 419 at the data vendor server 445 via the network 460 to generate the probability of the predicted next token. The generated predicted next token may also be sent to the user device 410 for review by the user 440 via the network 460.

The database 432 may be stored in a transitory and/or non-transitory memory of the server 430. In one implementation, the database 432 may store data obtained from the data vendor server 445. In one implementation, the database 432 may store parameters of the controllable text generation module 230. In one implementation, the database 432 may store previously generated predicted next token, and the corresponding input feature vectors.

In some embodiments, database 432 may be local to the server 430. However, in other embodiments, database 432 may be external to the server 430 and accessible by the server 430, including cloud storage systems and/or databases that are accessible over network 460.

The server 430 includes at least one network interface component 433 adapted to communicate with user device 410 and/or data vendor servers 445, 470 or 480 over network 460. In various embodiments, network interface component 433 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

### Example Work Flows

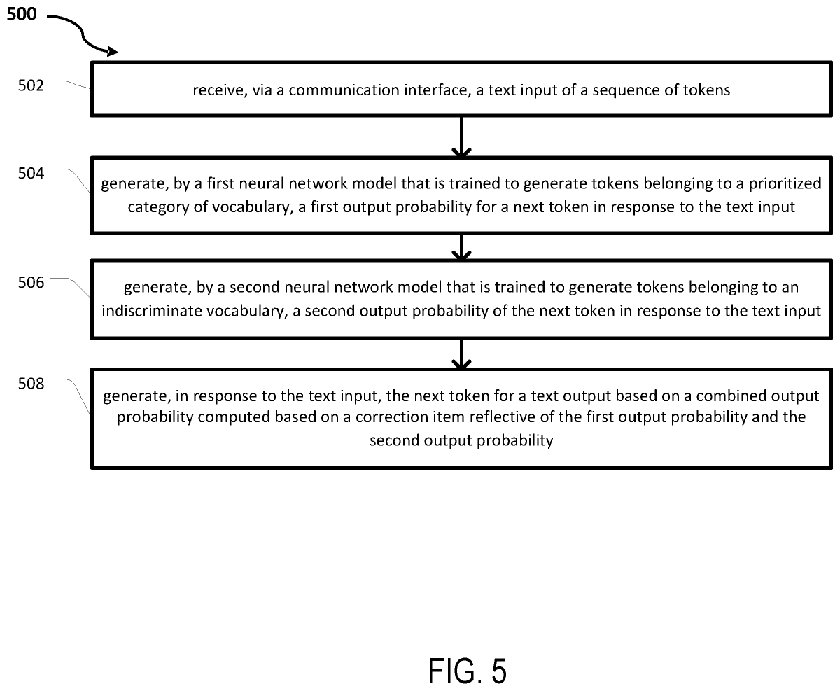

FIG. 5 is an example logic flow diagram illustrating a method of mitigating a prioritized category of vocabulary in the output token based on the framework shown in FIGS. 1A and 1B, according to some embodiments described herein. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operation of the controllable text generation module 230 (e.g., FIGS. 2 and 4) that performs mitigating toxic content (e.g., detoxification) in the output token.

As illustrated, the method 500 includes a number of enumerated steps, but aspects of the method 500 may include additional steps before, after, and in between the enumerated steps. In some aspects, one or more of the enumerated steps may be omitted or performed in a different order.

At step 502, a text input (e.g., prompt 102) of a sequence of tokens is received via a communication interface (e.g., data interface 215, network interfaces 417, 426, and/or 433).

At step 504, a first neural network model (e.g., detoxifier model 104) that is trained to generate tokens belonging to a prioritized category of vocabulary generates a first output probability (e.g., output probability 108) for a next token in response to the text input. In some embodiments, the first neural network model is trained using a training pair of a text input (e.g., text input 103) and a corresponding labeled output (e.g., labeled output 111) belonging to the prioritized category of vocabulary. In some embodiments, the first neural network model is trained using a training pair of a text input and a corresponding labeled output belonging to the prioritized category of vocabulary. In some embodiments, the training of the first neural network model further includes generating, by the first neural network model based on a number of virtual tokens, a training output (e.g., 109) in response to the text input. The training of the first neural network model further includes updating embeddings of the number of virtual tokens based on a loss (e.g., by loss calculation module 113) comparing the training output and the corresponding labeled output while keeping weights of the first neural network model unchanged. In some embodiments, the number of virtual tokens have the embeddings that are tunable.

In some embodiments, the generating, by the first neural network model the first output probability for the next token further includes restricting the next token to a number of tokens having corresponding cumulative output probabilities that are greater than a pre-defined threshold.

In some embodiments, the correction term is computed based on a difference between the second output probability and the first output probability.

At step 506, a second neural network model (e.g., generator model 106) that is trained to generate tokens belonging to an indiscriminate vocabulary generates a second output probability (e.g., output probability 110) of the next token in response to the text input. In some embodiments, the first neural network model and the second neural network model may share a same neural network structure, or the first neural network model (e.g., the detoxifier) may be significantly smaller in size than the second network model (e.g., the generator).

At step 508, in response to the text input, the next token for a text output is generated based on a combined output probability (e.g., combined probability 118) computed based on a correction item (e.g., correction item 120) reflective of the first output probability and the second output probability.

It is to be noted that the controllable text generation framework is not limited to embodiments relating to detoxifying toxic content from text generation, but may be applied to any text that favors a user-defined and user-controlled style. For example, detoxifier model 104 in FIGS. 1A-1B may be trained with training dataset designed with a labeled output that focuses on medical jargons, such that the detoxifier model 104 is trained to generate an output that favors a prioritized vocabulary of medical jargons. In this way, the controllable text generation framework 100 may generate an output that “detoxifies” such medical jargons, in order to provide a text response devoid of medical jargons for a layperson (e.g., a patient) to understand.

It is to be noted that the controllable text generation framework is not limited to embodiments relating to NLP task only. For example, both detoxifier model 104 and generator model 106 may comprise multi-modal language models that generate a text output in response to a multi-modal input, such as but not limited to image, video, code, audio, and/or the like. For instance, both detoxifier model 104 and generator model 106 may be a multi-modal language model that receives an input of an image and a text prompt instructing the model to textually describe “what is in the image.” In this way, the controllable text generation framework may be tuned and/or operated in a similar way as described in FIGS. 1-5 to generate a text description that mitigates toxic content, or any other user-defined unwanted content.

### Example Results

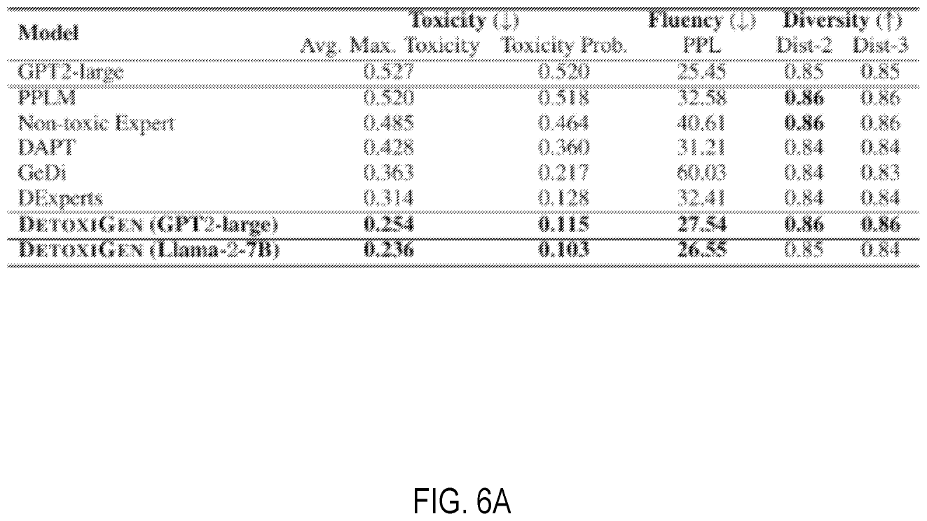

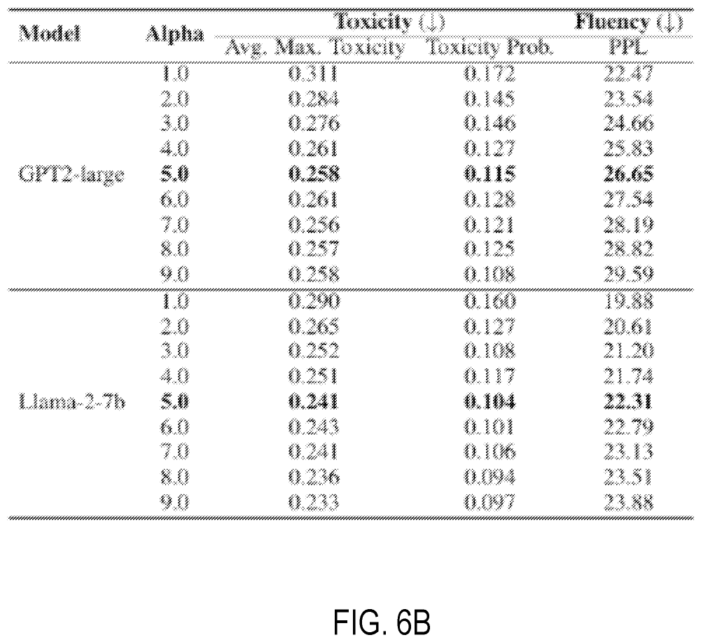

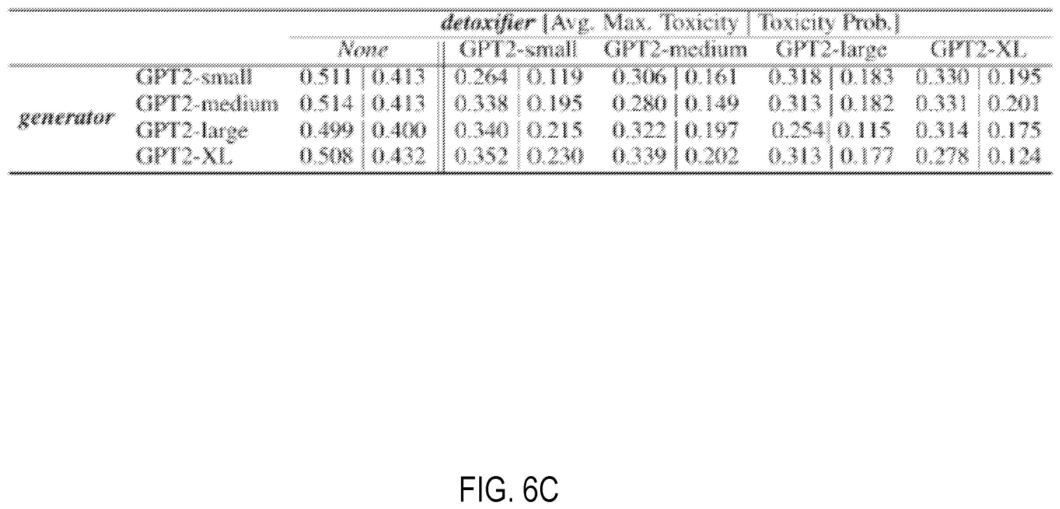

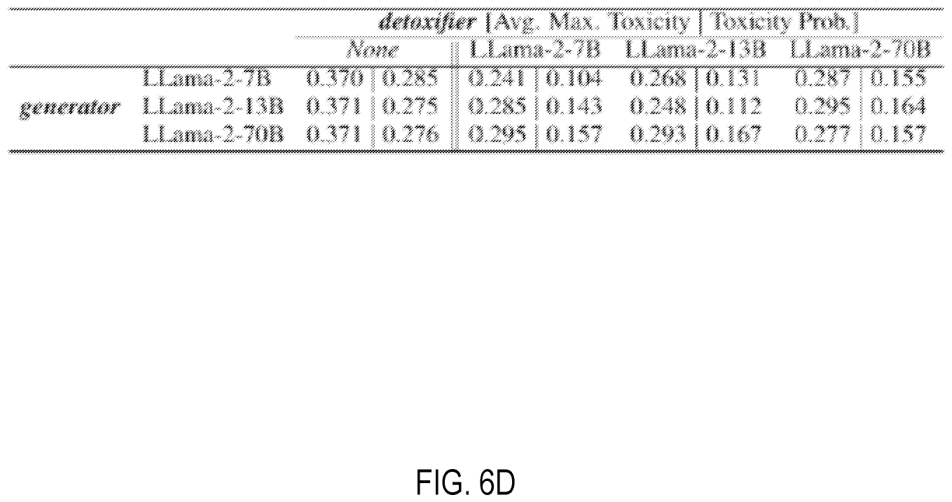

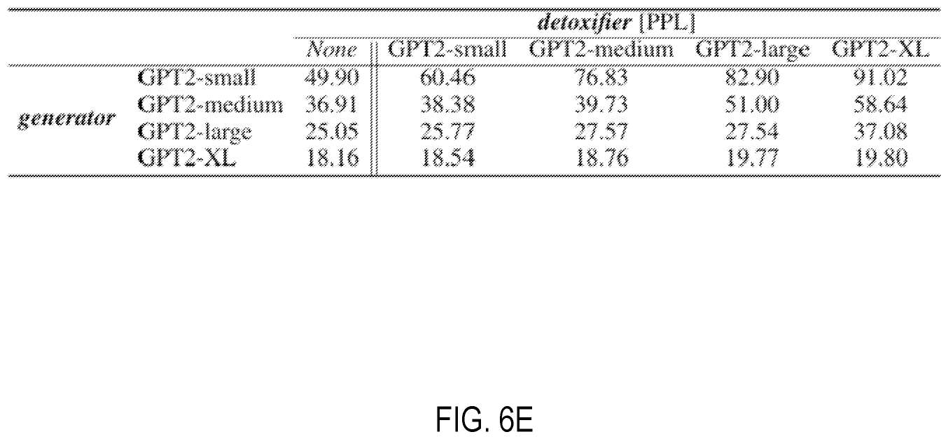

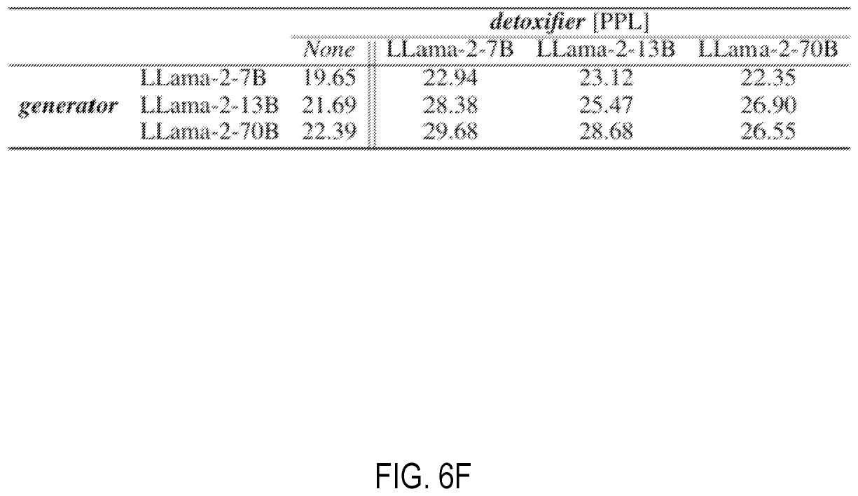

FIGS. 6A-6F represent exemplary test results using embodiments described herein. In some embodiments, GPT2-XL is used to evaluate the generation quality. For ablation studies reported, GPT2 with small and medium sizes is also considered. It is worth noting that previous work selected the GPT2 family mostly because it was one of the strongest models at the time. To observe if the same trend of performance holds for the most recent language models, another family of Transformer-based (Vaswani et al., Attention is all you need. In Proceedings of the 31st International Conference on Neural Information Processing Systems, NIPS′17, pp. 6000-6010, Red Hook, NY, USA, 2017) language models, namely Llama-2 (Touvron et al., Llama 2: Open foundation and fine-tuned chat models. arXiv preprint arXiv: 2307.09288, 2023.), is also experimented on because it satisfies the following three criteria: (1) It is publicly released so that it is easier for researchers to reproduce and compare with our work; (2) It achieves state-of-the-art performance on diverse benchmark datasets (Erik Nijkamp et al., Xgen-7b technical report. arXiv preprint arXiv: 2309.03450, 2023); (3) It has three sizes so that whether larger models can be paired with smaller ones for detoxification is evaluated. Criteria (3) is the setting when reducing latency over minimizing GPU memory footprint is prioritized. Hence Llama-2 with 7B, 13B, and 70B parameters are experimented on, respectively. Due to the large size of Llama-2-70B, for all experiments, bfloat 16 is used for both training and inference to increase throughput and reduce GPU memory usage. Perplexity from the Llama-2 family with Llama-2-7B is evaluated unless otherwise stated.

In some embodiments, the hyperparameter α is tuned with a held-out validation set and perform a grid search from 1.0 to 9.0 with a 1.0 increment. In some embodiments, it is found that α=5.0 strikes the best balance between toxicity and generation quality. This value is adopted throughout all experiments.

To evaluate controllable text generation framework 100, Liu et al. (DExperts: Decoding-time controlled text generation with experts and anti-experts. In Proceedings of the 59th Annual Meeting of the Association for Computational Linguistics and the 11th International Joint Conference on Natural Language Processing (Volume 1: Long Papers), pp. 6691-6706, Online, August 2021a.) is followed to use the REALTOXICITYPROMPTS dataset (Gehman et al., RealToxicityPrompts: Evaluating neural toxic degeneration in language models. In Findings of the Association for Computational Linguistics: EMNLP 2020, pp. 3356-3369, Online, November 2020.) which contains 100K naturally occurring, sentence-level prompts derived from a large corpus of English web text. These prompts are annotated with toxicity scores and language models are known to degenerate into toxic continuation when conditioning on them. To determine the strength a of detoxifier model 104, 1k prompts are randomly sampled as the validation set and another disjoint 10k as the test set.

FIG. 6A shows results on a random nontoxic 10K sample from the REALTOxtCITYPROMPTS dataset. On the first row, the downward arrows indicate “the lower the better”, while the upward ones indicate the opposite. Avg. Max. Toxicity stands for “Average Maximum Toxicity”, PPL stands for “Perplexity”, and all models are evaluated with GPT2-XL. Dist-N stands for the Distinct-N metric. All models in this table use GPT2-large as the backbone model, except for the last row where Llama-2-7B is used. State-of-the-art results are boldfaced.

Certain metrics are used to evaluate controllable text generation framework 100. Some metrics are related to toxicity. Following Gehman et al. (2020), the Perspective API² is used to measure the toxicity of generations. This score is obtained from a CNN model (Lecun et al., 1998) trained on a non-public corpus of Wikipedia comments. Two metrics are computed based on the toxicity scores following Liu et al. (2021a): (1) Average Maximum Toxicity: The average maximum toxicity over k=25 generations; (2) Toxicity Probability: The empirical probability of a generation with toxicity >0.5 for at least once over k=25 generations.

Some metrics are related to quality. The quality metric includes both fluency and diversity. Heeding both aspects makes it easier to spot cases where the generation is likely but generic, or diverse but unlikely. Corpus-level Perplexity is used to evaluate fluency and Distinct-2 and -3 (Li et al., A diversity-promoting objective function for neural conversation models. In Proceedings of the 2016 Conference of the North American Chapter of the Association for Computational Linguistics: Human Language Technologies, pp. 110-119, San Diego, California, June 2016.) to evaluate diversity. Distinct-2 and distinct-3 correspond respectively to the number of distinct bigrams and trigrams divided by the total number of generated words.

Controllable text generation framework 100 is compared with a diverse set of previously reported baseline models (Gehman et al., 2020; Liu et al., 2021a), including Domain-Adaptive Pretraining (DAPT) (Gururangan et al., Don't stop pretraining: Adapt language models to domains and tasks. In Proceedings of the 58th Annual Meeting of the Association for Computational Linguistics, pp. 8342-8360, Online, July 2020.), Plug-and-Play Language Models (PPLM) (Dathathri et al., Plug and play language models: A simple approach to controlled text generation. arXiv preprint arXiv: 1912.02164, 2019.), Non-Toxic Expert (Liu et al., 2021a), Generative Discriminators (GeDi) (Krause et al., GeDi: Generative discriminator guided sequence generation. In Findings of the Association for Computational Linguistics: EMNLP 2021, pp. 4929-4952, Punta Cana, Dominican Republic, November 2021.), and Decoding-time Experts (DExperts) (Liu et al., 2021a). Following these baselines, Nucleus Sampling with p=0.9 is used for generation.

As previously mentioned, a grid search of α with values 1.0, 2.0, . . . , 9.0 is performed. The results on both GPT2-large and Llama-2-7b are shown so that the trend on both early and more recent models can be observed. From FIG. 6B, it is seen that for both models, there is a steady increase in Perplexity (last column) as α grows, indicating a monotonic decrease in generation quality. Intuitively, this trend makes sense because the more the original output distribution is perturbed, the more likely it is for the language model to generate less plausible tokens. To maintain a balance between toxicity and quality, the tipping point is sought where further increasing α only brings a diminishing return on reducing toxicity. It is observed for both models, this tipping point happens at @=5.0. Hence this hyperparameter setting is adopted throughout all other experiments.

FIG. 6B shows validation results obtained by varying the strength & of detoxifier model 104 from 1.0 to 9.0 with GPT2-large and Llama-2-7b. Each setting is evaluated on a held-out validation set of size 1k from REAL-TOxtCITYPROMPTS. The boldfaced rows indicate tipping points where further increasing @ starts to bring diminishing (sometimes even negative) returns on the balance between toxicity and fluency.

Previous approaches on GPT2-large are compared. From FIG. 6A, it is seen that controllable text generation framework 100 outperforms previous frameworks by a large margin although only tuned on the toxic split of the training data. Among all models, controllable text generation framework 100 (GPT2-large) achieves the lowest Average Maximum Toxicity and Toxicity Probability, while obtaining a Perplexity that is quite close to that of the vanilla GPT-2 large, indicating minimum compromise on generation quality. The Llama-2-7B version of controllable text generation framework 100 achieves even better results. However, it is based on a much stronger backbone language model, hence not comparable to previous work. Llama-2 results are also included in this table to show the gap between earlier and more recent large language models. Liu et al. (2021a) is followed and reported with Distinct-N metrics, which are intended to prevent the model from degenerating into dull and generic continuations. It is observed that the Distinct-N results do not vary much across diverse kinds of models. Hence for the results reported afterwards, this metric is skipped and only Perplexity is reported.

In some embodiments, pairing models of different sizes as generator model 106 and detoxifier model 104, respectively, is also explored. This setting targets the cases where either latency is the major concern such that one small detoxifier model 104 is desired to steer the generation of all other model sizes, or when detoxifier model 104 is trained once and plug-and-play it with all other model sizes. Toxicity and quality are reported in separate figures to make the comparisons clearer. From FIGS. 6C-6F, a few interesting patterns are observed. FIG. 6C shows toxicity results by pairing models of different sizes from the GPT-2 model family. All results are obtained on the validation set of size 1K. The column with the header None indicates that no detoxifier model is used. FIG. 6D shows toxicity results by pairing models of different sizes from the Llama-2 model family. All results are obtained on the validation set of size 1K. The column with the header None indicates that no detoxifier model is used.

One pattern is consistent toxicity reduction. In FIGS. 6C-6F, it is observed that when comparing with the no-detoxifier setting (the column with None as header), controllable text generation framework 100 consistently and significantly reduces the toxicity of the backbone model while not sacrificing much on generation quality. This trend is observed for both the GPT-2 and the Llama-2 model families.

Another pattern is entries along the diagonal. As shown in FIGS. 6C and 6D, entries on the diagonal of the result matrix (i.e., without the first column that has None as the header) consistently outperform their neighbors in terms of toxicity. These are the settings where generator model 106 and detoxifier model 104 share exactly the same backbone language model. They also achieve the best row-wise Perplexity as compared to off-diagonal models (FIGS. 6E and 6F). It is hypothesized that this is because the output probability distributions of generator model 106 and detoxifier model 104 with the same underlying backbone parameters are more compatible with each other than backbones of different sizes. As mentioned previously, one of the major goals is to introduce as few new model parameters as possible. The cross-model results clearly show that sharing weights between generator model 106 and detoxifier model 104 turns out to be the best setting among all we have investigated.

Another pattern is entries symmetric to the diagonal. Comparing entries that are symmetric to the diagonal (e.g., comparing GPT2-XL detoxified by GPT2-small with GPT2-small detoxified by GPT2-XL) in FIGS. 6C and 6D, it is observed a consistent pattern that given two models of different sizes, it is usually better to have the smaller model as generator model 106 and the larger model as detoxifier model 104 for detoxification. This indicates that larger models are more capable of capturing the distribution in the toxicity training corpus.

Another pattern is effect of model size difference. From the toxicity figures, it is also observed that the larger the model size difference, the less effective the detoxification. For example, GPT2-XL detoxified by GPT2-small in FIG. 6C results in the worst toxicity among all settings, while it is observed that the same pattern where Llama-2-70B detoxified by Llama-2-7B has the highest toxicity among all settings.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for mitigating toxic content in text generation by a neural network based framework, comprising:
receiving, via a communication interface, a text input of a sequence of tokens;
generating, by a first neural network model that is trained to generate tokens belonging to a prioritized category of vocabulary, a first output probability for a next token in response to the text input;
generating, by a second neural network model that is trained to generate tokens belonging to an indiscriminate vocabulary, a second output probability of the next token in response to the text input; and
generating, in response to the text input, the next token for a text output based on a combined output probability computed based on a correction item reflective of the first output probability and the second output probability.

2. The method of claim 1, wherein the first neural network model is trained using a training pair of a text input and a corresponding labeled output belonging to the prioritized category of vocabulary.

3. The method of claim 2, wherein training the first neural network model further comprises:
generating, by the first neural network model based on a number of virtual tokens, a training output in response to the text input; and
updating embeddings of the number of virtual tokens based on a loss comparing the training output and the corresponding labeled output while keeping weights of the first neural network model unchanged.

4. The method of claim 3, wherein the number of virtual tokens have the embeddings that are tunable.

5. The method of claim 1, wherein the first neural network model and the second neural network model share a same neural network structure.

6. The method of claim 1, wherein the generating, by the first neural network model the first output probability for the next token further comprises:
restricting the next token to a number of tokens having corresponding cumulative output probabilities that are greater than a pre-defined threshold.

7. The method of claim 1, wherein the correction term is computed based on a difference between the second output probability and the first output probability.

8. A system for mitigating toxic content in text generation, the system comprising:
a memory that stores a first neural network model, a second neural network model, and a plurality of processor executable instructions;
a communication interface that receives a text input of a sequence of tokens; and
one or more hardware processors that read and execute the plurality of processor-executable instructions from the memory to perform operations comprising:
generating, by the first neural network model that is trained to generate tokens belonging to a prioritized category of vocabulary, a first output probability for a next token in response to the text input;
generating, by the second neural network model that is trained to generate tokens belonging to an indiscriminate vocabulary, a second output probability of the next token in response to the text input; and
generating, in response to the text input, the next token for a text output based on a combined output probability computed based on a correction item reflective of the first output probability and the second output probability.

9. The system of claim 8, wherein the first neural network model is trained using a training pair of a text input and a corresponding labeled output belonging to the prioritized category of vocabulary.

10. The system of claim 9, wherein training the first neural network model further comprises:
generating, by the first neural network model based on a number of virtual tokens, a training output in response to the text input; and
updating embeddings of the number of virtual tokens based on a loss comparing the training output and the corresponding labeled output while keeping weights of the first neural network model unchanged.

11. The system of claim 10, wherein the number of virtual tokens have the embeddings that are tunable.

12. The system of claim 8, wherein the first neural network model and the second neural network model share a same neural network structure.

13. The system of claim 8, wherein the operation of the generating, by the first neural network model the first output probability for the next token further comprises:
restricting the next token to a number of tokens having corresponding cumulative output probabilities that are greater than a pre-defined threshold.

14. The system of claim 8, wherein the correction term is computed based on a difference between the second output probability and the first output probability.

15. A non-transitory machine-readable medium comprising a plurality of machine-executable instructions which, when executed by one or more processors, are adapted to cause the one or more processors to perform operations comprising:
receiving, via a communication interface, a text input of a sequence of tokens;
generating, by a first neural network model that is trained to generate tokens belonging to a prioritized category of vocabulary, a first output probability for a next token in response to the text input;
generating, by a second neural network model that is trained to generate tokens belonging to an indiscriminate vocabulary, a second output probability of the next token in response to the text input; and
generating, in response to the text input, the next token for a text output based on a combined output probability computed based on a correction item reflective of the first output probability and the second output probability.

16. The non-transitory machine-readable medium of claim 15, wherein the first neural network model is trained using a training pair of a text input and a corresponding labeled output belonging to the prioritized category of vocabulary.

17. The non-transitory machine-readable medium of claim 16, wherein training the first neural network model further comprises:
generating, by the first neural network model based on a number of virtual tokens, a training output in response to the text input; and
updating embeddings of the number of virtual tokens based on a loss comparing the training output and the corresponding labeled output while keeping weights of the first neural network model unchanged.

18. The non-transitory machine-readable medium of claim 17, wherein the number of virtual tokens have the embeddings that are tunable.

19. The non-transitory machine-readable medium of claim 15, wherein the first neural network model and the second neural network model share a same neural network structure.

20. The non-transitory machine-readable medium of claim 15, wherein the generating, by the first neural network model the first output probability for the next token further comprises:
restricting the next token to a number of tokens having corresponding cumulative output probabilities that are greater than a pre-defined threshold.
